(19) United States
(12) Patent Application Publication
(10) Pub. No.: US 2012/0051290 A1
(43) Pub. Date: Mar. 1, 2012

(54) WIRELESS COMMUNICATION APPARATUS, WIRELESS COMMUNICATION METHOD, PROGRAM, AND INTEGRATED CIRCUIT

(76) Inventors: Koichi Murase, Osaka (JP); Makoto Funabiki, Osaka (JP)

(21) Appl. No.: 13/254,021

(22) PCT Filed: Mar. 1, 2010
(86) PCT No.: PCT/JP2010/001357

§ 371 Date: Nov. 3, 2011

(30) Foreign Application Priority Data
Mar. 3, 2009 (JP) 2009-048773

(51) Int. Cl. H04W 4/00

(52) U.S. Cl. 370/328

(57) ABSTRACT

A wireless communication apparatus (1000) includes a wired interface (1100) wire-connected to one or more apparatuses in accordance with the High-Definition Multimedia Interface (HDMI) Standard, a wireless interface (1200) wireless-connected to the other wireless communication apparatus, an address management table (1300) containing CEC logical addresses for identifying each of the apparatuses wire-connected to the pair of wireless communication apparatuses, a table update unit (1400) that updates the address management table (1300) upon receipt of a message indicating that the apparatus connected on the side of one of the wired interface (1100) and the wireless interface (1200), and a control unit (1500) that notifies the apparatus present on the side of the other of the wired interface (1100) and the wireless interface (1200) that the table update unit (1400) has updated the address management table (1300).

### TECHNICAL FIELD

The present invention relates to a wireless communication apparatus that enables relay transmission of an HDMI-CEC message between a plurality of wireless communication apparatuses.

### BACKGROUND ART

A Consumer Electronics Control (hereinafter, CEC) message used in a High-Definition Multimedia Interface (hereinafter, HDMI) standardized in NPL 1 is usually transmitted and received between wire-connected apparatuses.

A wireless communication system that executes wireless relay transmission of the CEC message can be found, for example, in PTL 1.

FIG. 18 is a block diagram showing a configuration of the wireless communication system disclosed in PTL 1. In FIG. 18, the wireless communication system includes a source apparatus 1A, a sink apparatus 2A, an adapter 57, and another adapter 67.

The source apparatus 1A includes a wired transmission/reception circuit 55, a controller 10A, a ROM 11, a DVD player 13, and a CEC controller 14. The sink apparatus 2A includes a wired transmission/reception circuit 65, a controller 20A, a ROM 21, a speaker 22, a display 23, a CEC controller 24, and an audio/visual signal processing circuit 30. The adapter 57 includes a controller 50, a wired transmission/reception circuit 51, a RAM 52, a wireless transmission/reception circuit 54, and an antenna 56. The adapter 67 includes a controller 60, a wired transmission/reception circuit 61, a RAM 62, a wireless transmission/reception circuit 64, and an antenna 66.

The source apparatus 1A and the adapter 57 are mutually wire-connected through a cable C1. The sink apparatus 2A and the adapter 67 are mutually wire-connected through a cable C2. The adapters 57 and 67 are wireless-connected.

The controller 10A of the source apparatus 1A outputs a CEC message inputted from the CEC controller 14 to the wired transmission/reception circuit 55. The controller 10A also outputs a CEC message received from the sink apparatus 2A through the wired transmission/reception circuit 55 and the adapter 57, to the CEC controller 14. The wired transmission/reception circuit 55 transmits a visual signal and an audio signal read out from the DVD player 13, or a CEC message inputted from the controller 10A to the adapter 57, through the cable C1. The wired transmission/reception circuit 55 also receives from the adapter 57 a CEC message transmitted from the sink apparatus 2A, through the cable C1.

The wired transmission/reception circuit 51 of the adapter 57 receives a visual signal and an audio signal from the source apparatus 1A through the cable C1, and outputs those signals to the wireless transmission/reception circuit 54. The wired transmission/reception circuit 51 receives a CEC message from the source apparatus 1A through the cable C1, and transmits the CEC message to the controller 50. Further, the wired transmission/reception circuit 51 transmits a CEC message transmitted from the sink apparatus 2A to the source apparatus 1A through the cable C1. The controller 50 generates a wireless data packet containing a CEC message outputted from the wired transmission/reception circuit 51, and outputs the wireless data packet to the wireless transmission/reception circuit 54. The controller 50 stores transmission data information of a CEC message outputted by the controller 50 in a transmission data information table 52a in the RAM 52. Further, the controller 50 executes an address information registration process and a data transmission/reception process on the basis of a CEC message contained in a wireless data packet received from the sink apparatus 2A through the wireless transmission/reception circuit 54 and the antenna 56. The RAM 52 contains the transmission data information table 52a and a node information table 52b.

The controller 20A and the wired transmission/reception circuit 65 of the sink apparatus 2A are configured similarly to the controller 10A and the wired transmission/reception circuit 55 of the source apparatus 1A, respectively. However, the wired transmission/reception circuit 65 outputs an audio/visual signal received through the cable C2 to the audio/visual signal processing circuit 30. Also, the controller 20A controls the audio/visual signal processing circuit 30.

The controller 60, the wired transmission/reception circuit 61, the RAM 62 and the wireless transmission/reception circuit 64 of the adapter 67 are configured similarly to the controller 50, the wired transmission/reception circuit 51, the RAM 52 and the wireless transmission/reception circuit 54 of the adapter 57, respectively. However, the RAM 62 contains a transmission data information table 62a and a node information table 62b. The wireless transmission/reception circuit 64 also outputs an audio/visual signal to the wired transmission/reception circuit 61.

Referring to FIG. 19, an operation of the wireless communication system thus configured will be described.

As shown in an upper part of FIG. 19, first the adapter 57 collects CEC logical addresses of the apparatuses connected thereto through the cable C1 (in this example, the source apparatus 1A), and stores the addresses in the node information table 52b. The adapter 57 then wirelessly transmits a list exchange message containing a list of CEC logical addresses stored in the node information table 52b to the adapter 67, for example at a timing that the node information table 52b is updated.

The adapter 67 stores the list of CEC logical addresses contained in the list exchange message received, in the node information table 62b. The adapter 67 also performs a similar operation with respect to the adapter 67 (not shown). Accordingly, the adapters 57, 67 can recognize the CEC logical address of the apparatus connected thereto and the CEC logical address of the apparatus connected to the mating adapter.

Referring to a lower part of FIG. 19, the source apparatus 1A transmits a CEC message for the sink apparatus 2A to the adapter 57.

More specifically, the CEC message generated by the CEC controller 14 of the source apparatus 1A is outputted to the controller 10A through a bus B1, and transmitted to the adapter 57 through the wired transmission/reception circuit 55 and the cable C1.

Then the controller 50 of the adapter 57 generates a wireless data packet containing the CEC message received from the source apparatus 1A through the wired transmission/reception circuit 51, and wirelessly transmits the generated wireless data packet to the adapter 67 through the wireless transmission/reception circuit 54 and the antenna 56.

The wireless transmission/reception circuit 64 of the adapter 57 wirelessly receives the wireless data packet through the antenna 56. The controller 60 of the adapter 67 refers the destination logical address of the CEC message contained in the wireless data packet to the node information table 62b. The controller 60 then transmits, in the case where the destination logical address agrees with the CEC logical address of the sink apparatus 2A, the CEC message to the sink apparatus 2A through the wired transmission/reception circuit 61 and the cable C2, and transmits a wireless ACK packet to the adapter 57 through the wireless transmission/reception circuit 64 and the antenna 66.

On the part of the source apparatus 1A, the CEC controller 14 retransmits the CEC message in the case where the wireless ACK packet is not received in a predetermined time after transmitting the CEC message. In this case, the controller 50 of the adapter 57 receives the wireless ACK packet from the adapter 67 by the time that an EOM bit of a data block N of the retransmitted CEC message is received from the CEC controller 14. Accordingly, the adapter 57 transmits an ACK bit representing “0” with respect to the data block N to the CEC controller 14, without wirelessly retransmitting the wireless data packet containing the CEC message. The CEC controller 14 can thus recognize that the CEC message has been normally received by the adapter 67.

As described above, in the conventional wireless communication system according to PTL 1, the CEC controller 14 and the controller 50 that generate the CEC message are connected to each other through the bus B1 and the cable C1, and the CEC controller 24 and the controller 60 are connected to each other through the bus B2 and the cable C2. Accordingly, the source apparatus 1A and the sink apparatus 2A can perform wireless transmission and reception of a CEC message by being connected to the adapter 57 and 67 respectively, despite having only a wired interface for transmitting and receiving a CEC message.

### CITATION LIST

### Patent Literature

[PTL 1] Japanese Unexamined Patent Application Publication No. 2008-22560 (page 22, FIG. 15)

### Non Patent Literature

[NPL 1] High-Definition Multimedia Interface Specification, Version 1.1, HDMI Licensing, LLC, California in U.S.A. (May 20, 2004)

### SUMMARY OF INVENTION

### Technical Problem

In the foregoing wireless communication system, since transmission and reception of the list exchange message is not performed between the source apparatus 1A and the adapter 57 and between the sink apparatus 2A and the adapter 67, the source apparatus 1A and the sink apparatus 2A are unable to recognize latest information of the apparatus connected to a point beyond the wireless section. More specifically, although a CEC apparatus capable of transmitting/receiving a CEC message is newly connected to the cable C2 of the adapter 67, the source apparatus 1A is unable to detect the presence of the new CEC apparatus, unless the source apparatus 1A itself performs polling or the like.

Another drawback of the conventional system is that it is difficult for the source apparatus 1A to receive an ACK/NACK packet responding to the first outputted CEC message, before a retransmission timer runs out. Accordingly, in the system according to PTL 1 the CEC controller 14 is supposed to retransmit the CEC message, and the adapter 57 is expected to receive the wireless ACK packet prior to receipt of the retransmitted CEC message.

In the conventional system, therefore, the transmission of a CEC message is not normally completed until NACK is received in response to a first outputted CEC message and the CEC controller 14 retransmits the CEC message. In addition, in accordance with the Standard the CEC bus works at a low speed and a long stand-by time is set for the retransmission, which leads to significant degradation in throughput.

Accordingly, a first object of the present invention is to provide a wireless communication apparatus capable of detecting a change in composition of CEC apparatuses at a desired timing.

A second object of the present invention is to provide a wireless communication apparatus capable of improving throughput of a CEC message transmitted and received between CEC apparatuses.

### Solution to Problem

In an aspect, the present invention provides a wireless communication apparatus being one of a pair of wireless communication apparatuses wireless-connected to each other, each wireless communication apparatus being wire-connected to one or more apparatuses. More specifically, the wireless communication apparatus includes a wired interface wire-connected to the one or more apparatuses in accordance with the High-Definition Multimedia Interface (HDMI) Standard, a wireless interface wireless-connected to the other of the pair of wireless communication apparatuses, an address management table that stores a CEC logical address for identifying the respective apparatus wire-connected to the pair of wireless communication apparatuses, a table update unit configured to update the address management table upon receipt of a message indicating that the apparatus connected on the side of one of the wired interface and the wireless interface has been changed, and a control unit configured to notify the apparatus connected on the side of the other of the wired interface and the wireless interface that the table update unit has updated the address management table.

With the foregoing configuration, the CEC logical address of the apparatus wire-connected to the other wireless communication apparatus is managed utilizing the address management table, and the update of the address management table is notified to the apparatus wire-connected to the wireless communication apparatus. Therefore, the apparatus wire-connected to the wireless communication apparatus can constantly recognize a latest composition of apparatuses. Here, “apparatus connected on the side of the wired interface” refers to the one or more apparatuses wire-connected to the wireless communication apparatus. Also, “apparatus connected on the side of the wireless interface” refers to the one or more apparatuses wire-connected to the other wireless communication apparatus.

In an embodiment, the table update unit may be configured to update, upon receipt of a list exchange message containing a list of CEC logical addresses of the apparatuses wire-connected to the other wireless communication apparatus from the other wireless communication apparatus through the wireless interface, the address management table with the CEC logical address contained in the list exchange message. The control unit may be configured to output a LOW-level pulse for a predetermined period of time to a “Hot Plug Detect” signal line or a “+5 V Power” signal line included in the wired interface, to thereby notify the apparatus connected on the side of the wired interface that the address management table has been updated.

Also, the control unit may further be configured to continue outputting the LOW-level pulse to the “Hot Plug Detect” signal line or the “+5 V Power” signal line included in the wired interface, until a first receipt of the list exchange message from the other wireless communication apparatus after the wireless communication apparatus is activated. Such an arrangement prevents the apparatus wire-connected to the wireless communication apparatus from acquiring erroneous CEC logical address information.

In another embodiment, the table update unit may be configured to add, upon receipt of a given CEC message through the wireless interface, a CEC logical address indicating the source of the CEC message to the address management table in the case where the CEC logical address is not contained in the address management table. The control unit may be configured to transmit a report physical address message specified in the HDMI Standard to the apparatus connected on the side of the wired interface, to thereby notify the CEC logical address added to the address management table. Here, the control unit may transmit a report physical address message generated by itself, or may relay a report physical address message generated by the other apparatus as described below.

The control unit may be configured to transmit a give physical address message specified in the HDMI Standard to the apparatus identified by the added CEC logical address, and to relay the report physical address message generated by the identified apparatus to the apparatus connected on the side of the wired interface. Such an arrangement eliminates the need for the wireless communication apparatus to acquire and manage the CEC physical address.

In still another embodiment, the table update unit may be configured to add, upon receipt of a given CEC message through the wired interface, a CEC logical address indicating the source of the CEC message to the address management table in the case where the CEC logical address is not contained in the address management table. The control unit may be configured to transmit a report physical address message specified in the HDMI Standard to the apparatus connected on the side of the wireless interface, to thereby notify the CEC logical address added to the address management table. Here, the control unit may transmit a report physical address message generated by itself, or may relay a report physical address message generated by the other apparatus as described below.

The control unit may be configured to transmit a give physical address message specified in the HDMI Standard to the apparatus identified by the added CEC logical address, and to relay the report physical address message generated by the identified apparatus to the apparatus connected on the side of the wireless interface. Such an arrangement eliminates the need for the wireless communication apparatus to acquire and manage the CEC physical address.

The wireless communication unit may further include a non-volatile memory. The table update unit may be configured to store, each time the address management table is updated, a copy of one or more of the CEC logical addresses contained in the updated address management table in the non-volatile memory. Also, the table update unit may be configured to add, when the wireless communication apparatus is activated, at least one of a CEC logical address indicating a root apparatus and a broadcast address to the one or more CEC logical addresses stored in the non-volatile memory, and to store a copy of the added address in the address management table. Such an arrangement allows the CEC message to be relayed immediately upon activating the wireless communication apparatus.

The control unit may be configured to transmit, upon receipt of a given CEC message through the wired interface, the CEC message to the destination apparatus through the wireless interface, and to transmit an acknowledgement signal indicating the receipt of the CEC message to the apparatus that is the source of the CEC message through the wired interface, in the case where the CEC logical address indicating a destination of the CEC message is contained in the address management table. Such an arrangement eliminates the need to retransmit the CEC message unlike a conventional wireless communication apparatus, and enables the throughput of the CEC message transmitted and received between the apparatuses to be significantly improved.

In another aspect, the present invention provides a method of wireless communication to be executed by a wireless communication apparatus being one of a pair of wireless communication apparatuses wireless-connected to each other, each wireless communication apparatus being wire-connected to one or more apparatuses, for wireless communication with the other of the pair of wireless communication apparatuses. The one of the pair of wireless communication apparatuses includes a wired interface wire-connected to the one or more apparatuses in accordance with the High-Definition Multimedia Interface (HDMI) Standard, a wireless interface wireless-connected to the other of the pair of wireless communication apparatuses, and an address management table containing a CEC logical address for identifying the respective apparatus wire-connected to the pair of wireless communication apparatuses. The method includes updating the address management table upon receipt of a message indicating that the apparatus connected on the side of one of the wired interface and the wireless interface has been changed, and notifying the apparatus connected on the side of the other of the wired interface and the wireless interface that the address management table has been updated in the updating the address management table.

In still another aspect, the present invention provides a program causing a wireless communication apparatus being one of a pair of wireless communication apparatuses wireless-connected to each other, each wireless communication apparatus being wire-connected to one or more apparatuses, to perform wireless communication with the other of the pair of wireless communication apparatuses. The one of the pair of wireless communication apparatuses includes a wired interface wire-connected to the one or more apparatuses in accordance with the High-Definition Multimedia Interface (HDMI) Standard, a wireless interface wireless-connected to the other of the pair of wireless communication apparatuses, and an address management table containing a CEC logical address for identifying the respective apparatus wire-connected to the pair of wireless communication apparatuses. The program causes the one of the pair of wireless communication apparatuses to update the address management table upon receipt of a message indicating that the apparatus connected on the side of one of the wired interface and the wireless interface has been changed, and to notify the apparatus connected on the side of the other of the wired interface and the wireless interface that the address management table has been updated in the updating the address management table.

In still another aspect, the present invention provides an integrated circuit for use in a wireless communication apparatus being one of a pair of wireless communication apparatuses wireless-connected to each other, each wireless communication apparatus being wire-connected to one or more apparatuses. The one of the pair of wireless communication apparatuses includes a wired interface wire-connected to the one or more apparatuses in accordance with the High-Definition Multimedia Interface (HDMI) Standard, and a wireless interface wireless-connected to the other of the pair of wireless communication apparatuses. The integrated circuit includes an address management table that stores a CEC logical address for identifying the respective apparatus wire-connected to the pair of wireless communication apparatuses, a table update unit configured to update the address management table upon receipt of a message indicating that the apparatus connected on the side of one of the wired interface and the wireless interface has been changed, and a control unit configured to notify the apparatus connected on the side of the other of the wired interface and the wireless interface that the table update unit has updated the address management table.

### ADVANTAGEOUS EFFECTS OF INVENTION

The present invention enables the respective CEC apparatus to constantly recognize a latest composition of apparatuses.

### BRIEF DESCRIPTION OF DRAWINGS

FIG. 1 is a block diagram of a wireless communication apparatus according to an embodiment of the present invention.

FIG. 2 is a block diagram of a wireless communication system according to an embodiment 1.

FIG. 3 is a data flow diagram showing an operation of the wireless communication system according to the embodiment 1.

FIG. 4 is a flowchart showing an operation of the wireless communication system according to the embodiment 1.

FIG. 5 is a data flow diagram showing another operation of the wireless communication system according to the embodiment 1.

FIG. 6 is a block diagram of a wireless communication system according to an embodiment 2.

FIG. 7 is a data flow diagram showing an operation of the wireless communication system according to the embodiment 2.

FIG. 8 is a block diagram of a wireless communication system according to an embodiment 3.

FIG. 9 is a data flow diagram showing an operation of the wireless communication system according to the embodiment 3.

FIG. 10 is a block diagram of a wireless communication system according to an embodiment 4.

FIG. 11 is a data flow diagram showing an operation of the wireless communication system according to the embodiment 4.

FIG. 12 is a block diagram of a wireless communication system according to an embodiment 5.

FIG. 13 is a data flow diagram showing an operation of the wireless communication system according to the embodiment 5.

FIG. 14 is a block diagram of a wireless communication system according to an embodiment 6.

FIG. 15 is a flowchart showing an operation of the wireless communication system according to the embodiment 6.

FIG. 16 is a flowchart showing another operation of the wireless communication system according to the embodiment 6.

FIG. 17 is a flowchart showing still another operation of the wireless communication system according to the embodiment 6.

FIG. 18 is a block diagram showing a configuration of a conventional wireless communication system.

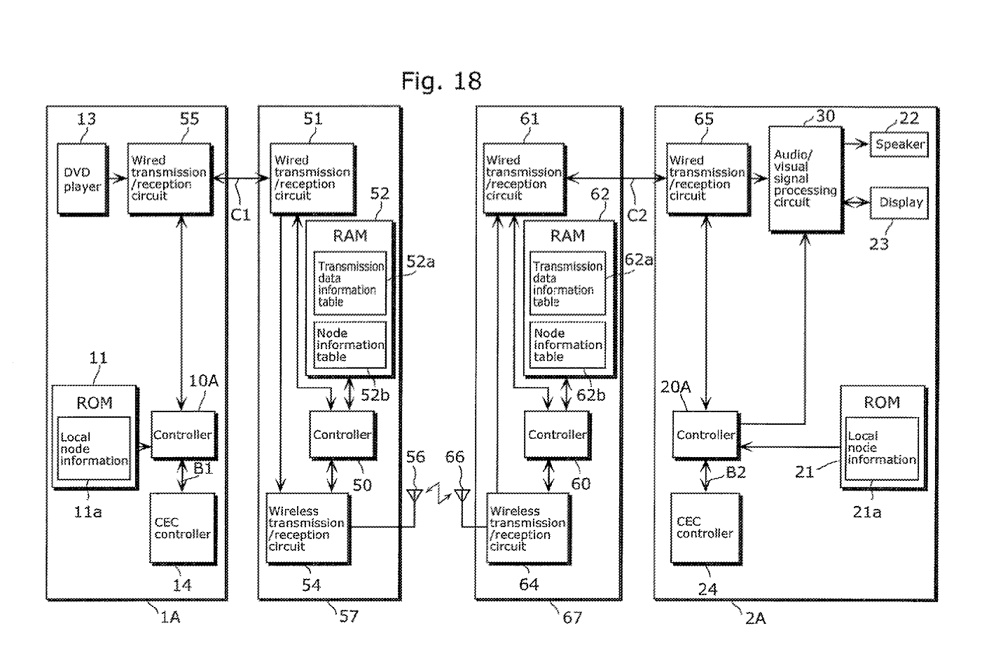

FIG. 19 is a data flow diagram showing an operation of the conventional wireless communication system.

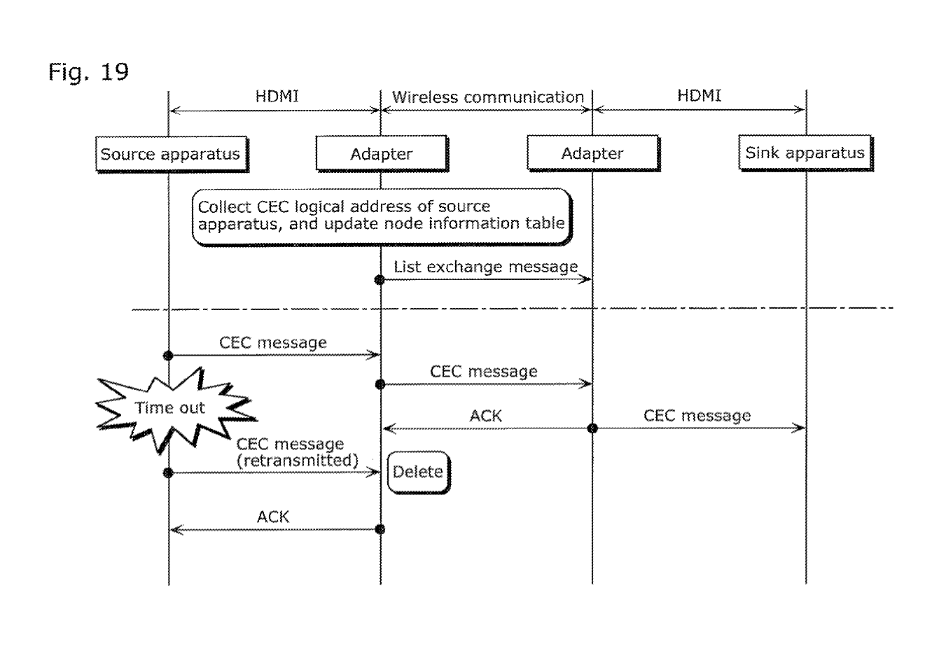

### DESCRIPTION OF EMBODIMENTS

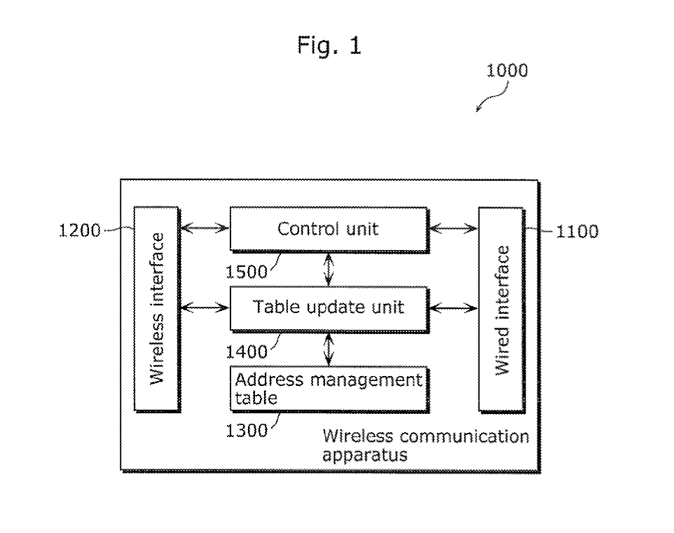

FIG. 1 is a block diagram of a wireless communication apparatus 1000 according to an embodiment of the present invention. As shown therein, the wireless communication apparatus 1000 includes a wired interface 1100, a wireless interface 1200, an address management table 1300, a table update unit 1400, and a control unit 1500.

The wired interface 1100 is configured in accordance with the HDMI Standard. One or more apparatuses may be directly or indirectly connected to the wired interface 1100. Here, the expression “directly connected” literally means that the wired interface 1100 and the apparatus are connected through a cable. The expression “indirectly connected” means that an additional apparatus is connected to the apparatus directly connected to the wired interface 1100.

The wireless interface 1200 is to be wireless-connected to another wireless communication apparatus. The connection method is not specifically limited, but the connection may be made, for example, in accordance with the WirelessHD specification.

The address management table 1300 contains CEC logical addresses of the apparatuses wire-connected to the wireless communication apparatus 1000 and apparatuses wire-connected to another wireless communication apparatus wireless-connected through the wireless interface 1200. The CEC logical address is a 4-bit value (0 to 15) for identifying the respective apparatuses connected in accordance with the HDMI Standard. The address management table 1300 is stored in a volatile memory such as a dynamic random access memory (DRAM) or a static random access memory (SRAM).

The table update unit 1400 updates a content of the address management table 1300 on the basis of messages received through the wired interface 1100 and the wireless interface 1200. The control unit 1500 notifies the apparatuses connected on the side of the wired interface 1100 and of the wireless interface 1200 that the table update unit 1400 has updated the address management table 1300. Specific operations of the table update unit 1400 and the control unit 1500 will be subsequently described.

### Embodiment 1

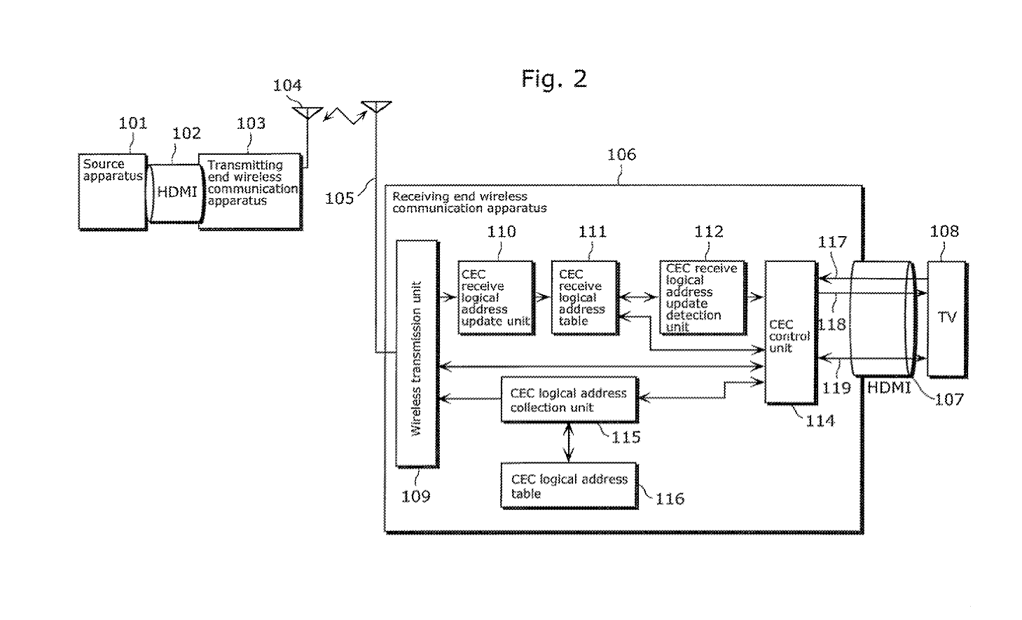

FIG. 2 is a block diagram showing an exemplary configuration of a wireless communication system that includes a wireless communication apparatus according to an embodiment 1 of the present invention. In FIG. 2, a receiving-end wireless communication apparatus 106 is connected to a TV 108 through a HDMI cable 107, and constitutes an “HDMI Sink” according to the HDMI Standard. A transmitting-end wireless communication apparatus 103 is connected to a source apparatus 101 through an HDMI cable 102, and constitutes an “HDMI Source” according to the HDMI Standard.

The HDMI cable 107 includes a signal line according to the HDMI Standard. For example, the HDMI cable 107 includes a hot plug detect (HPD) signal line 117 and a “+5 V power” signal line 118, and a CEC signal line 119. The HDMI cable 102 is also configured in the same way.

Here, the configuration in which the transmitting-end wireless communication apparatus 103 and the receiving-end wireless communication apparatus 106 constitute the “HDMI Source” and the “HDMI Sink” respectively is also adopted in subsequent embodiments. Although a single source apparatus 101 is wire-connected to the transmitting-end wireless communication apparatus 103 in FIG. 2, a plurality of CEC apparatuses may be wire-connected. In this case, another CEC apparatus may be connected to the source apparatus 101 (i.e., indirectly connected to the transmitting-end wireless communication apparatus 103), or the transmitting-end wireless communication apparatus 103 may include a plurality of wired interfaces for direct connection to a plurality of CEC apparatuses. This also applies to the receiving-end wireless communication apparatus 106.

The source apparatus 101 may be exemplified by an audio/visual reproduction apparatus such as a DVD player or a set top box (STB, for example a tuner). Although the TV 108 is adopted as an example of the sink apparatus in the present invention, the sink apparatus may be an audio/visual output (display) apparatus such as a speaker or a displayer.

The transmitting-end wireless communication apparatus 103 and the receiving-end wireless communication apparatus 106 are examples of the wireless communication apparatus 1000 shown in FIG. 1, and the internal structure and operation are the same. Accordingly, the receiving-end wireless communication apparatus 106 will be focused on for description of the embodiment 1.

The receiving-end wireless communication apparatus 106 shown in FIG. 2 includes an antenna 105, a wireless transmission unit 109, a CEC receive logical address update unit 110, a CEC receive logical address table 111, a CEC receive logical address update detection unit 112, a CEC control unit 114, a CEC logical address collection unit 115, a CEC logical address table 116, and a wired interface (not shown).

The antenna 105 and the wireless transmission unit 109 correspond, for example, to the wireless interface 1200 shown in FIG. 1. The CEC control unit 114 corresponds to the control unit 1500 shown in FIG. 1, for example. The CEC receive logical address update unit 110, the CEC receive logical address update detection unit 112, and the CEC logical address collection unit 115 correspond to the table update unit 1400 shown in FIG. 1, for example. Likewise, the CEC receive logical address table 111 and the CEC logical address table 116 correspond, for example, to the address management table 1300 shown in FIG. 1.

The wired interface which is not shown (corresponding to the wired interface 1100 in FIG. 1) is connected to the TV 108 through the HDMI cable 107. The wireless transmission unit 109, which includes a high-frequency circuit, a baseband processing circuit, a medium access control circuit and so forth, may operate in accordance with any existing wireless transmission system, and hence the description will be skipped in this embodiment. For example, a wireless transmission method utilizing a radio wave of 2.4 GHz band or 5 GHz band according to IEEE 802.11, or a method utilizing a millimeter wave may be employed.

In the present invention, an apparatus connected to a HDMI cable and capable of transmitting and receiving a CEC frame will be referred to as a “CEC apparatus”. Accordingly, the source apparatus 101 is a CEC apparatus connected to the transmitting-end wireless communication apparatus 103, and the TV 108 is another CEC apparatus connected to the receiving-end wireless communication apparatus 106.

The CEC control unit 114 transmits and receives a CEC frame to and from the TV 108 through the CEC signal line 119 in the HDMI cable 107, as well as to and from the wireless transmission unit 109. Other functions of the CEC control unit 114 includes outputting a LOW-level pulse of a predetermined time width to the “+5 V Power” signal line 118, and acquiring HPD signal information from the TV 108 through the HPD signal line 117.

The CEC receive logical address update unit 110 registers a CEC logical address notified by the source apparatus 101 or the transmitting-end wireless communication apparatus 103 through the antenna 105 and the wireless transmission unit 109, in the CEC receive logical address table 111.

The CEC receive logical address update detection unit 112 periodically monitors the registered content of the CEC receive logical address table 111, and notifies, upon detecting an update of the content, the CEC control unit 114 to this effect. The CEC control unit 114 outputs a LOW-level pulse of a predetermined time width to the “+5 V Power” signal line 118, thereby notifying the TV 108 that the apparatus composition in the wireless transmission system has undergone a change. Here, the function of the CEC receive logical address update detection unit 112 according to this embodiment may be assigned to the CEC receive logical address update unit 110. In this case, the CEC receive logical address update unit 110 both updates the content of the CEC receive logical address table 111 and notifies the update to the CEC control unit 114.

The CEC control unit 114 decides, upon receipt of a CEC frame from the TV 108 through the CEC signal line 119, whether a destination address contained in the CEC frame is registered in the CEC receive logical address table 111. In the affirmative case, the CEC control unit 114 accepts the CEC frame and outputs the CEC frame to the wireless transmission unit 109. The CEC control unit 114 also outputs an acknowledgement signal (ACK) in response to the CEC frame, to the CEC signal line 119.

In contrast, in the case where the destination address is not registered in the CEC receive logical address table 111, the CEC control unit 114 deletes the CEC frame instead of accepting, and outputs a non-acknowledgement signal (NACK) in response to the CEC frame, to the CEC signal line 119.

The CEC logical address collection unit 115 periodically collects the CEC logical addresses of the CEC apparatuses connected to the CEC signal line 119, through the CEC control unit 114. The CEC logical address collection unit 115 then registers the collected CEC logical addresses in the CEC logical address table 116. Also, the CEC logical address collection unit 115 notifies, upon deciding that the content of the CEC logical address table 116 has been updated, the update to the transmitting-end wireless communication apparatus 103 and the source apparatus 101 through the wireless transmission unit 109 and the antenna 105.

Here, although the transmitting-end wireless communication apparatus 103 is configured similarly to the receiving-end wireless communication apparatus 106, a difference is that the CEC control unit of the transmitting-end wireless communication apparatus 103 outputs a LOW-level pulse of a predetermined time width to the HPD signal line, instead of to the “+5 V Power” signal line.

Hereunder, an operation according to the present invention will be described, primarily referring to the receiving-end wireless communication apparatus 106.

The CEC logical address table 116 contains a list of CEC logical addresses of the CEC apparatuses connected to the CEC signal line 119 in the HDMI cable 107 of the receiving-end wireless communication apparatus 106. The CEC logical address is registered as follows according to this embodiment, which is merely exemplary. The CEC logical address collection unit 115 of the receiving-end wireless communication apparatus 106 periodically performs polling to the CEC signal line 119 through the CEC control unit 114. Alternatively, the CEC logical address collection unit 115 extracts a source CEC logical address contained in the CEC frame received from the CEC signal line 119.

Then the CEC logical address collection unit 115 stores the collected CEC logical addresses in the CEC logical address table 116. The CEC logical address collection unit 115 further compares the current content of the CEC logical address table 116 with the previous content, and transmits a wireless data packet (list exchange message) containing the list of CEC logical addresses to the transmitting-end wireless communication apparatus 103 through the wireless transmission unit 109 and the antenna 105, in the case where the CEC logical address collection unit 115 has detected an update of the list of CEC logical addresses.

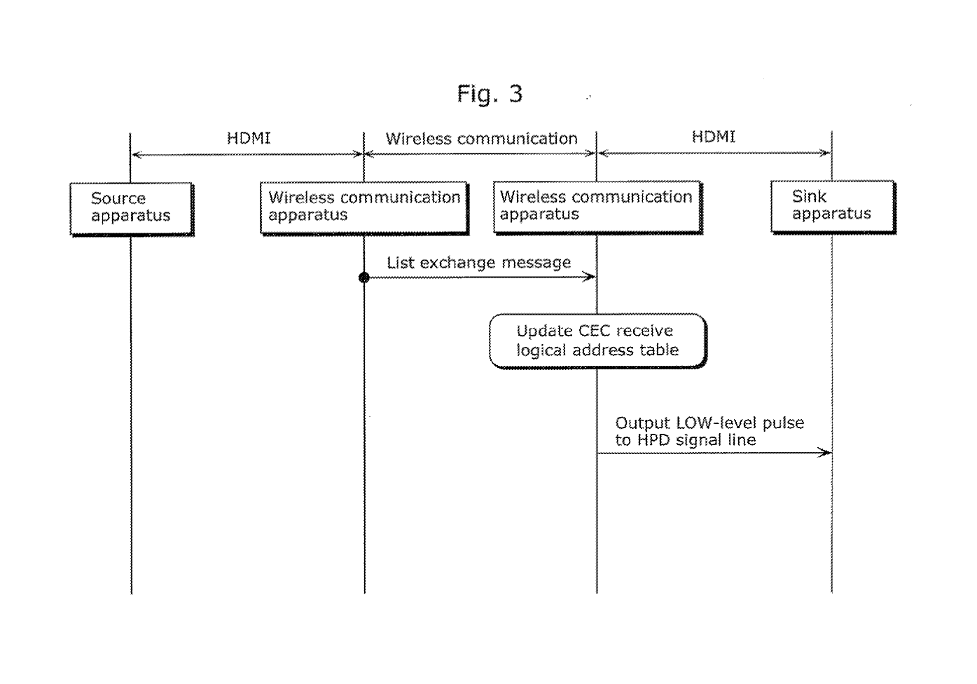

Likewise, the transmitting-end wireless communication apparatus 103 wirelessly transmits a wireless data packet (list exchange message) containing a list of CEC logical addresses to the receiving-end wireless communication apparatus 106 as shown in FIG. 3, in the case where the CEC logical address table in the transmitting-end wireless communication apparatus 103 is updated.

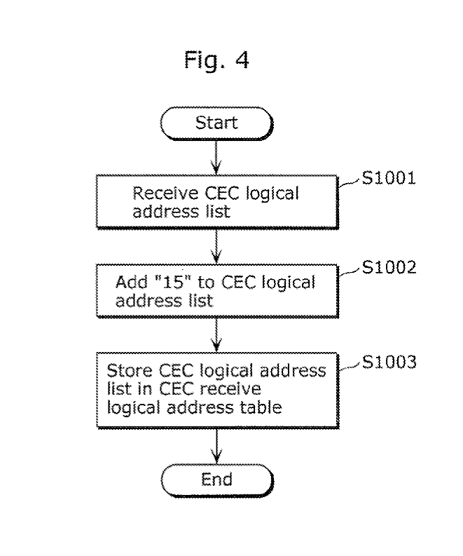

The receiving-end wireless communication apparatus 106 receives the wireless data packet containing the list of CEC logical addresses through the antenna 105 and the wireless transmission unit 109 (step S1001 in FIG. 4), and notifies the CEC logical addresses to the CEC receive logical address update unit 110. The CEC receive logical address update unit 110 updates the CEC receive logical address table 111 in accordance with the received CEC logical addresses (step S1003). In this process, in the case where a broadcast address “15” is not contained in the list of CEC logical addresses contained in the received wireless data packet, it is preferable to add “15” to the list (step S1002) before storing the CEC logical addresses in the CEC receive logical address table 111.

Then the CEC receive logical address update detection unit 112 detects the update of the CEC receive logical address table 111, and notifies the update to the CEC control unit 114. The CEC control unit 114 outputs, upon receipt of such a notice, a LOW-level pulse of a predetermined time width to the “+5 V Power” signal line 118 as shown in FIG. 3, to thereby notify the TV 108 that a new CEC logical address has been registered.

The TV 108 performs polling to the apparatus directly or indirectly connected to the HDMI cable 107 upon detecting that the LOW-level pulse of the predetermined time width has been outputted to the “+5 V Power” signal line 118, to thereby collect the CEC logical addresses.

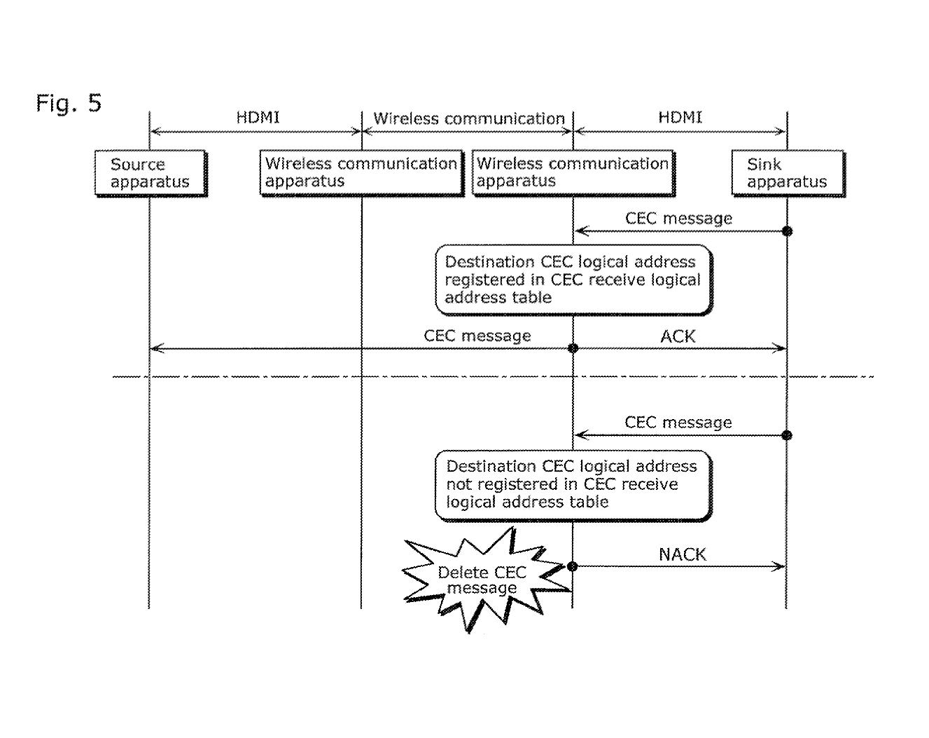

When the TV 108 transmits a CEC frame containing a CEC message for the source apparatus 101 through the CEC signal line 119 as shown in FIG. 5, the CEC control unit 114 decides whether the CEC destination logical address contained in the CEC frame received through the CEC signal line 119, i.e., the CEC logical address of the source apparatus 101, is registered in the CEC receive logical address table 111.

Since the CEC logical address of the source apparatus 101 is registered in the CEC receive logical address table 111 in this example, the CEC control unit 114 accepts the CEC frame and outputs an ACK in response to the CEC frame to the CEC signal line 119, as shown in an upper part of FIG. 5. Then the CEC control unit 114 generates a wireless data packet containing the CEC message received from the TV 108, and transmits the wireless data packet to the transmitting-end wireless communication apparatus 103 through the wireless transmission unit 109 and the antenna 105.

The transmitting-end wireless communication apparatus 103 extracts the CEC message from the wireless data packet received through the antenna 104 to thereby generate a CEC frame, and transmits the CEC frame to the source apparatus 101 through the HDMI cable 102.

On the other hand, in the case where the CEC destination logical address in the CEC frame transmitted by the TV 108 is not registered in the CEC receive logical address table 111, the CEC control unit 114 deletes the CEC frame and outputs a NACK in response to the CEC frame to the CEC signal line 119, as shown in a lower part of FIG. 5.

Likewise, a CEC message for the TV 108 transmitted by the source apparatus 101 is inputted to the CEC receive logical address update unit 110 and the CEC control unit 114 through the transmitting-end wireless communication apparatus 103, antenna 104, and the antenna 105. The CEC control unit 114 generates a CEC frame on the basis of the received CEC message, and outputs the CEC frame to the TV 108 through the HDMI cable 107.

The CEC receive logical address update unit 110 decides whether the source CEC logical address of the inputted CEC message is registered in the CEC receive logical address table 111. In the negative case, the CEC receive logical address update unit 110 registers the source CEC logical address in the CEC receive logical address table 111 as a new address.

The CEC receive logical address update detection unit 112 detects that the CEC receive logical address update unit 110 has updated the CEC receive logical address table 111, and notifies the CEC control unit 114 to this effect. The CEC control unit 114 notifies, upon receipt of the notice from the CEC receive logical address update detection unit 112, the update of the CEC receive logical address table 111 to the CEC apparatus having the CEC logical address (TV 108 in this embodiment), through the CEC signal line 119. More specifically, the CEC control unit 114 outputs a LOW-level pulse of a predetermined time width to the “+5 V Power” signal line 118, thereby notifying the TV 108 that the new address has been registered.

Thus, according to this embodiment, since the CEC logical address of the CEC apparatus wire-connected to the transmitting-end wireless communication apparatus 103 is managed utilizing the CEC receive logical address table 111, and the update of the CEC receive logical address table 111 is notified to the TV 108, the TV 108 can constantly recognize a latest composition of apparatuses.

Also, in the case where the CEC destination address of a received CEC message is registered in the CEC receive logical address table 111, an ACK can be outputted at a proper timing. Such an arrangement eliminates the need to retransmit the CEC message unlike a conventional wireless communication apparatus, and enables the throughput of the CEC message transmitted and received between the source apparatus 101 and the TV 108 to be significantly improved.

Although the CEC receive logical address update unit 110 is configured to receive a list of CEC logical addresses from another wireless communication apparatus according to this embodiment, the CEC receive logical address update unit 110 may extract a source CEC logical address upon receipt of a wireless data packet containing a CEC message, to thereby update the CEC receive logical address table.

The receiving-end wireless communication apparatus 106 may maintain the “+5 V Power” signal line 118 (HPD signal line in the transmitting-end wireless communication apparatus 103) at a LOW level, after being activated until a wireless data packet containing a first list of CEC logical addresses is received and the CEC receive logical address table 111 is updated. Such an arrangement prevents the CEC apparatus connected to the receiving-end wireless communication apparatus 106 from acquiring erroneous CEC logical address information.

### Embodiment 2

According to an embodiment 2, the receiving-end wireless communication apparatus 206 is configured to notify itself the other CEC apparatuses that the system composition has undergone a change, upon detecting a change of a CEC apparatus wire-connected to the transmitting-end wireless communication apparatus 203.

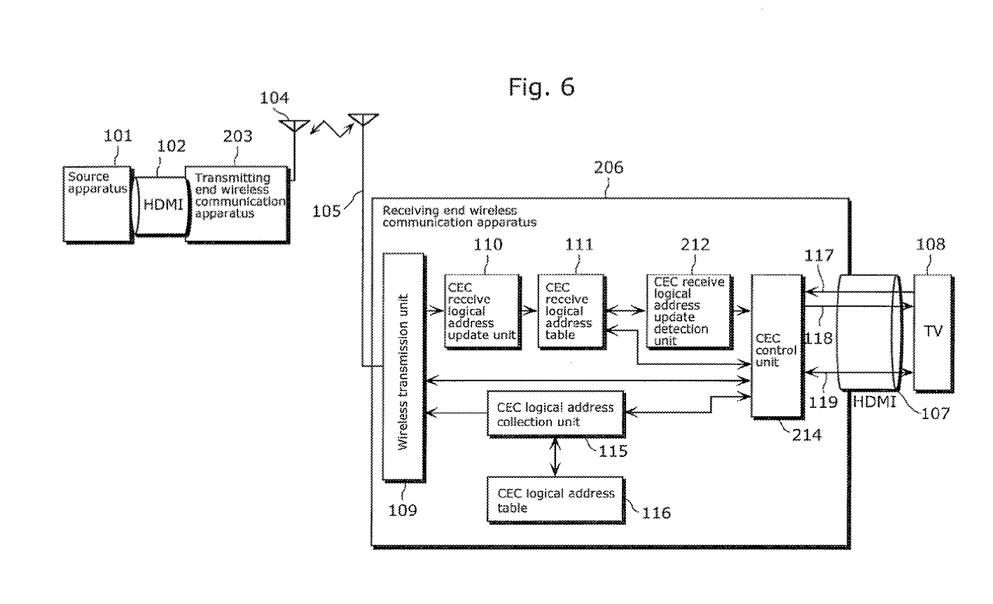

FIG. 6 is a block diagram showing a configuration of a wireless communication system that includes a wireless communication apparatus according to the embodiment 2 of the present invention. In FIG. 6, the constituents that act in the same way as in the embodiment 1 will be given the same numeral, and description thereof will not be repeated. The transmitting-end wireless communication apparatus 203 and the receiving-end wireless communication apparatus 206 are modified examples of the wireless communication apparatus 1000 shown in FIG. 1, and the correspondence between the constituents is the same as in the embodiment 1.

Referring to FIG. 6, a CEC receive logical address update detection unit 212 notifies a CEC control unit 214 that a new address has been registered in the CEC receive logical address table 111, upon detecting the new registration. The CEC control unit 214 generates a CEC frame containing a report physical address message, one of the CEC messages specified in the HDMI Standard, upon receipt of the notice of the registration of the new address from the CEC receive logical address update detection unit 212, and outputs the report physical address message to the CEC signal line 119, thereby notifying the TV 108 that the composition of the wireless communication system has undergone a change.

The following description is based on the assumption that a CEC apparatus has been newly connected to the source apparatus 101 wire-connected to the transmitting-end wireless communication apparatus 203.

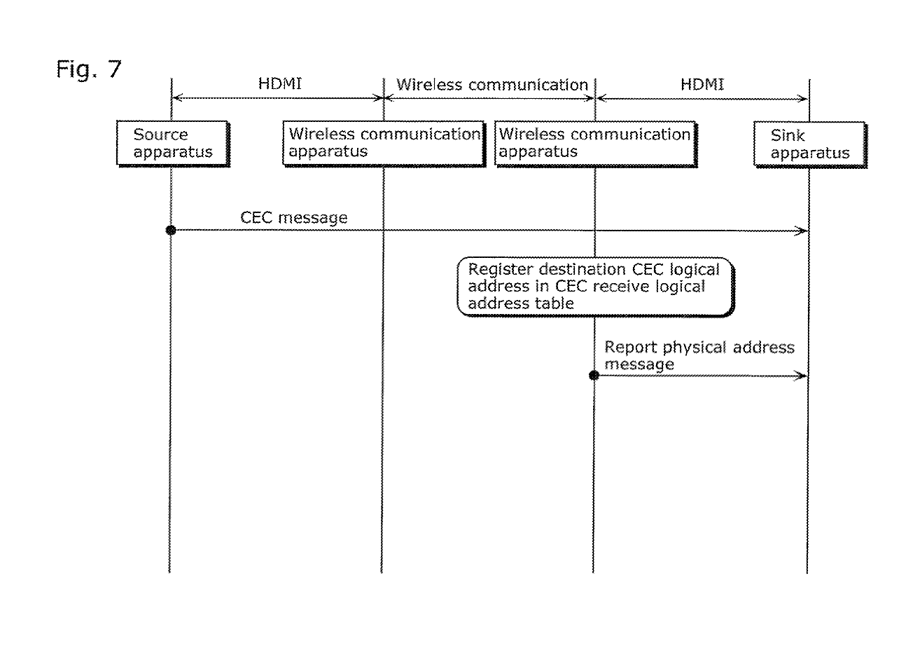

Referring to FIG. 7, a CEC message destined for the TV 108 transmitted by the CEC apparatus (not shown) newly connected to the source apparatus 101 is inputted to the CEC receive logical address update unit 110 and the CEC control unit 214 through the transmitting-end wireless communication apparatus 203, the antenna 104, and the antenna 105. The CEC control unit 214 generates a CEC frame on the basis of the received CEC message, and outputs the CEC frame to the TV 108 through the HDMI cable 107.

The CEC receive logical address update unit 110 decides whether the CEC logical address of the source of the inputted CEC message is registered in the CEC receive logical address table 111. In the negative case, the CEC receive logical address update unit 110 registers the CEC logical address in the CEC receive logical address table 111 as a new address.

The CEC receive logical address update detection unit 212 detects that the new CEC logical address has been registered in the CEC receive logical address table 111, and notifies the CEC control unit 214 to this effect. The CEC control unit 214 generates a CEC frame containing the report physical address message upon receipt of the notice from the CEC receive logical address update detection unit 212, and outputs the CEC frame to the CEC signal line 119. Here, the report physical address message generated at this stage contains the CEC physical address and the CEC logical address of the CEC apparatus newly connected to the source apparatus 101.

The TV 108 recognizes that the CEC apparatus has been newly connected to the system on the part of the source apparatus 101, upon receipt of the CEC frame.

Here, the function of the CEC receive logical address update detection unit 212 according to this embodiment may be assigned to the CEC receive logical address update unit 110. In this case, the CEC receive logical address update unit 110 both updates the content of the CEC receive logical address table 111 and notifies the update to the CEC control unit 214.

The configuration according to this embodiment eliminates the need to output a LOW-level pulse to the “+5 V power” signal line 118 or the HPD signal line 117 for notifying a change in composition of CEC apparatuses wire-connected to the transmitting-end wireless communication apparatus 203. Outputting a LOW-level pulse to the “+5 V power” signal line 118 or the HPD signal line 117 interrupts the visual signal and the audio signal, and resynchronization has to be performed. However, the configuration according to this embodiment prevents the visual signal and the audio signal from being interrupted, when a notice of a change in system composition of the CEC apparatuses is transmitted.

### Embodiment 3

A receiving-end wireless communication apparatus 306 according to an embodiment 3 is configured to cause, upon detecting a change of a CEC apparatus wire-connected to the transmitting-end wireless communication apparatus 303, the apparatus that has undergone the change to notify the change in system composition to the other CEC apparatuses.

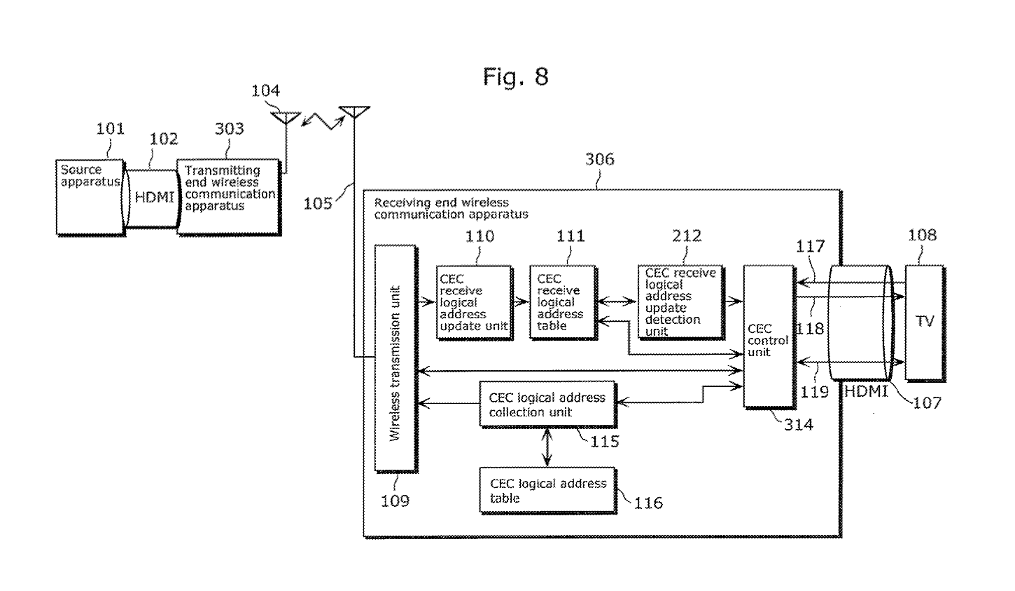

FIG. 8 is a block diagram showing a configuration of a wireless communication system that includes the wireless communication apparatus according to the embodiment 3 of the present invention.

In FIG. 8, the constituents that act in the same way as in the first and the embodiment 2 will be given the same numeral, and description thereof will not be repeated. The transmitting-end wireless communication apparatus 303 and the receiving-end wireless communication apparatus 306 are modified examples of the wireless communication apparatus 1000 shown in FIG. 1, and the correspondence between the constituents is the same as in the embodiment 1.

The CEC receive logical address update detection unit 212 notifies a CEC control unit 314 that a new address has been registered in the CEC receive logical address table 111, upon detecting the new registration. The CEC control unit 314 generates a give physical address message, one of the CEC messages specified in the HDMI Standard, upon receipt of the notice of the registration of the new address from the CEC receive logical address update detection unit 212, and transmits the give physical address message to the newly connected CEC apparatus through the wireless transmission unit 109, the antenna 105, and the transmitting-end wireless communication apparatus 303.

Hereunder, an operation according to this embodiment will be described in details.

The following description is based on the assumption that a CEC apparatus has been newly connected to the source apparatus 101 wire-connected to the transmitting-end wireless communication apparatus 303.

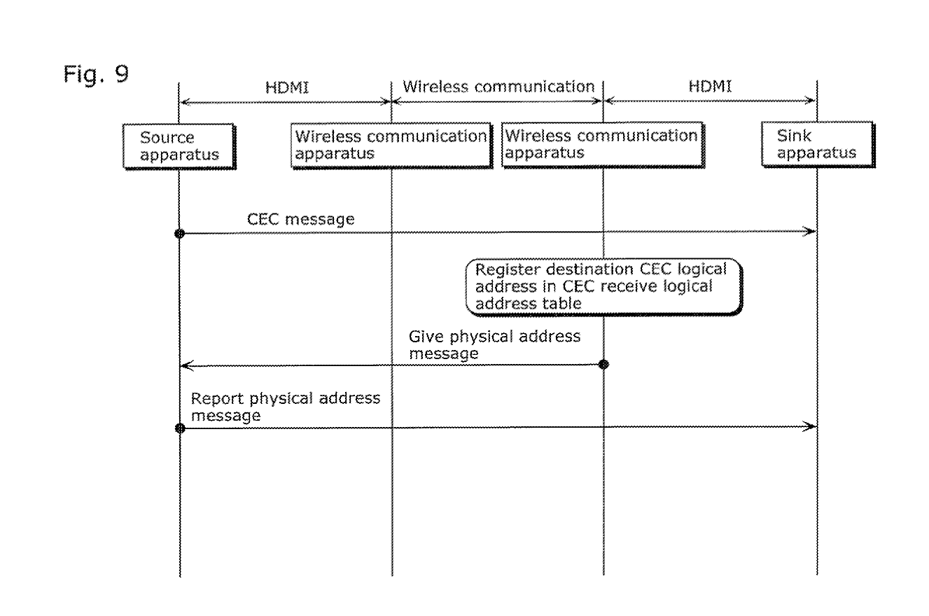

Referring to FIG. 9, a CEC message destined for the TV 108 transmitted by the CEC apparatus (not shown) newly connected to the source apparatus 101 is inputted to the CEC receive logical address update unit 110 and the CEC control unit 214 through the transmitting-end wireless communication apparatus 203, the antenna 104, and the antenna 105. The CEC control unit 214 generates a CEC frame on the basis of the received CEC message, and outputs the CEC frame to the TV 108 through the HDMI cable 107.

The CEC receive logical address update unit 110 decides whether the CEC logical address of the source of the inputted CEC message is registered in the CEC receive logical address table 111. In the negative case, the CEC receive logical address update unit 110 registers the CEC logical address in the CEC receive logical address table 111 as a new address.

The CEC receive logical address update detection unit 212 detects that the new CEC logical address has been registered in the CEC receive logical address table 111, and notifies the CEC control unit 314 to this effect. The CEC control unit 314 generates a wireless data packet containing a give physical address message upon receipt of the notice of the registration of the new address from the CEC receive logical address update detection unit 212, and wirelessly transmits the wireless data packet to the transmitting-end wireless communication apparatus 303 through the wireless transmission unit 109 and the antenna 105.

The transmitting-end wireless communication apparatus 303 generates a CEC frame containing the give physical address message upon receipt of the wireless data packet from the receiving-end wireless communication apparatus 306 through the antenna 104, and outputs the CEC frame to the CEC apparatus newly connected to the source apparatus 101, through the CEC signal line of the HDMI cable 102.

The CEC apparatus newly connected to the source apparatus 101 generates a CEC frame containing a report physical address message in accordance with the HDMI Standard upon receipt of the give physical address message, and outputs the CEC frame to the transmitting-end wireless communication apparatus 303 through the source apparatus 101. Here, the report physical address message generated at this stage contains the CEC physical address and the CEC logical address of the CEC apparatus newly connected to the source apparatus 101.

The transmitting-end wireless communication apparatus 303 generates a wireless data packet containing a report physical address message, and wirelessly transmits the wireless data packet to the receiving-end wireless communication apparatus 306 through the antenna 104.

The receiving-end wireless communication apparatus 306 generates a CEC frame containing the report physical address message upon receipt of the wireless data packet containing the report physical address message, and outputs the CEC frame to the TV 108 through the CEC control unit 314 and the CEC signal line 119. The TV 108 acquires the CEC logical address of the CEC apparatus newly connected to the system on the part of the source apparatus 101, from the received CEC frame.

The receiving-end wireless communication apparatus 206 according to the embodiment 2 has to have an additional device for acquiring and managing the CEC physical address necessary for the report physical address message. According to the embodiment 3, however, since the report physical address message is generated by the CEC apparatus itself that has received the give physical address message, the receiving-end wireless communication apparatus 306 does not have to acquire or manage the CEC physical address.

### Embodiment 4

A receiving-end wireless communication apparatus 406 according to an embodiment 4 is configured to cause, upon detecting a change of a CEC apparatus wire-connected thereto, the apparatus that has undergone the change to notify the change in system composition to the other CEC apparatuses.

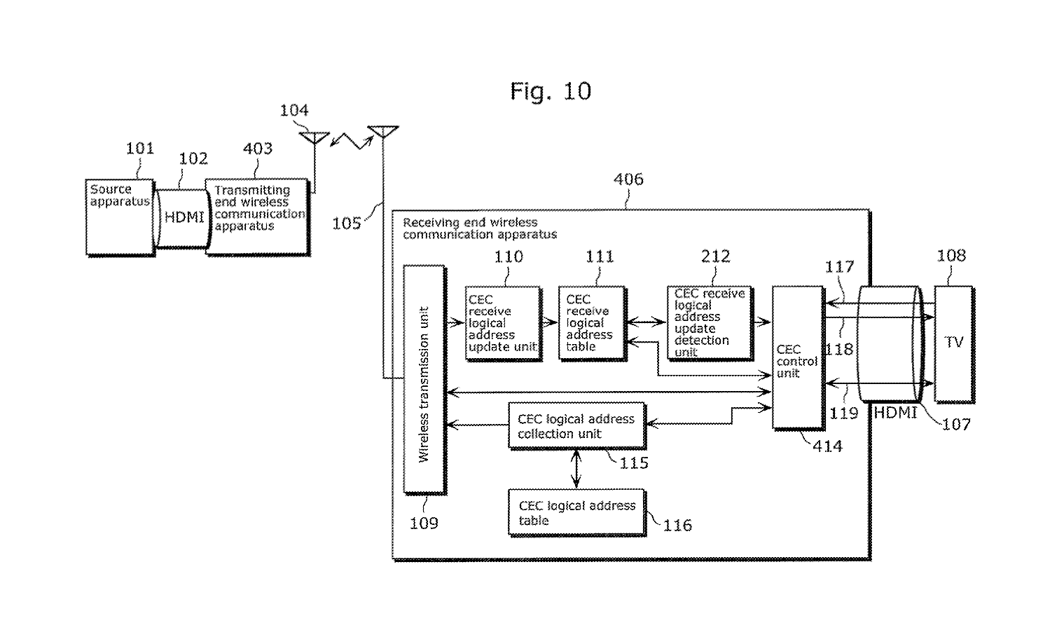

FIG. 10 is a block diagram showing a configuration of a wireless communication system that includes the wireless communication apparatus according to the embodiment 4 of the present invention. In FIG. 10, the same constituents as those of the embodiments 1 to 3 will be given the same numeral, and description thereof will not be repeated. The transmitting-end wireless communication apparatus 403 and the receiving-end wireless communication apparatus 406 are modified examples of the wireless communication apparatus 1000 shown in FIG. 1, and the correspondence between the constituents is the same as in the embodiment 1.

Referring to FIG. 10, a CEC control unit 414 generates a CEC frame containing a give physical address message, and outputs the CEC frame to the CEC signal line 119. A TV 408 detects whether the system composition including the other CEC apparatuses connected through the HDMI signal line has undergone a change, upon receipt of the CEC frame from the CEC control unit 414. In the affirmative case, the TV 408 notifies the change in system composition to the mating system of CEC apparatuses in the wireless communication system.

Hereunder, an operation according to this embodiment will be described in details.

The following description is based on the assumption that a CEC apparatus has been newly connected to the TV 408 wire-connected to the receiving-end wireless communication apparatus 406.

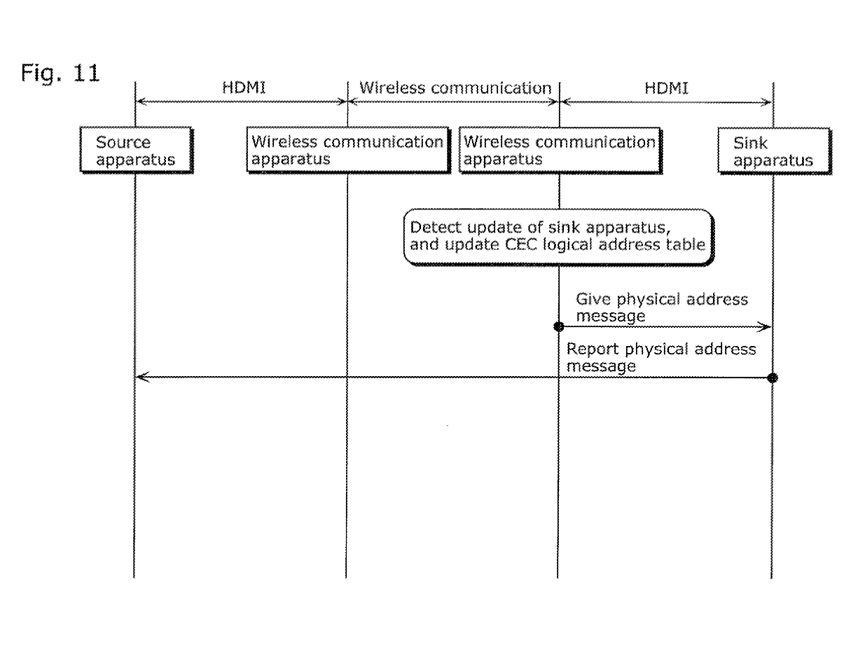

Referring to FIG. 11, the CEC logical address collection unit 115 watches a change in system composition of the CEC apparatuses directly or indirectly connected to the HDMI cable 107. The watching method is not specifically limited, but the CEC logical address collection unit 115 may, for example, periodically perform polling to thereby detect an addition or deletion of the CEC apparatus, or watch the source address of a CEC message received through the CEC signal line 119.

The CEC logical address collection unit 115 notifies the CEC control unit 414 that a new CEC apparatus (not shown) has been connected to the TV 408, i.e., the content of the CEC logical address table 116 has been updated, upon detecting the update. The CEC control unit 414 generates a CEC frame containing a give physical address message upon receipt of the notice from the CEC logical address collection unit 115, and outputs the CEC frame to the CEC apparatus newly connected to the TV 408 through the CEC signal line 119.

The CEC apparatus newly connected to the TV 408 generates a CEC frame containing a report physical address message in accordance with the HDMI Standard upon receipt of the give physical address message, and outputs the CEC frame to the receiving-end wireless communication apparatus 406 through the TV 408. Here, the report physical address message generated at this stage contains the CEC physical address and the CEC logical address of the CEC apparatus newly connected to the TV 408.

The CEC control unit 414 outputs the CEC frame containing the report physical address message received from the newly connected CEC apparatus through the CEC signal line 119 to the wireless transmission unit 109. The wireless transmission unit 109 generates a wireless data packet containing the CEC message received from the CEC control unit 414, and wirelessly transmits the wireless data packet to the transmitting-end wireless communication apparatus 403 through the antenna 105.

The transmitting-end wireless communication apparatus 403 generates a CEC frame containing the report physical address message upon receipt of the wireless data packet containing the report physical address message, and outputs the CEC frame to the HDMI cable 102, thereby notifying the source apparatus 101 that the CEC apparatus has been newly connected to the TV 408.

According to the embodiment 4, a CEC apparatus that has made a change in composition of CEC apparatuses wire-connected to the receiving-end wireless communication apparatus 406 can notify the change in system composition to the other CEC apparatuses in the wireless communication system.

### Embodiment 5

A receiving-end wireless communication apparatus 506 according to an embodiment 5 is configured to notify itself the other CEC apparatuses that the composition of CEC apparatuses wire-connected thereto has undergone a change, upon detecting the change in system composition.

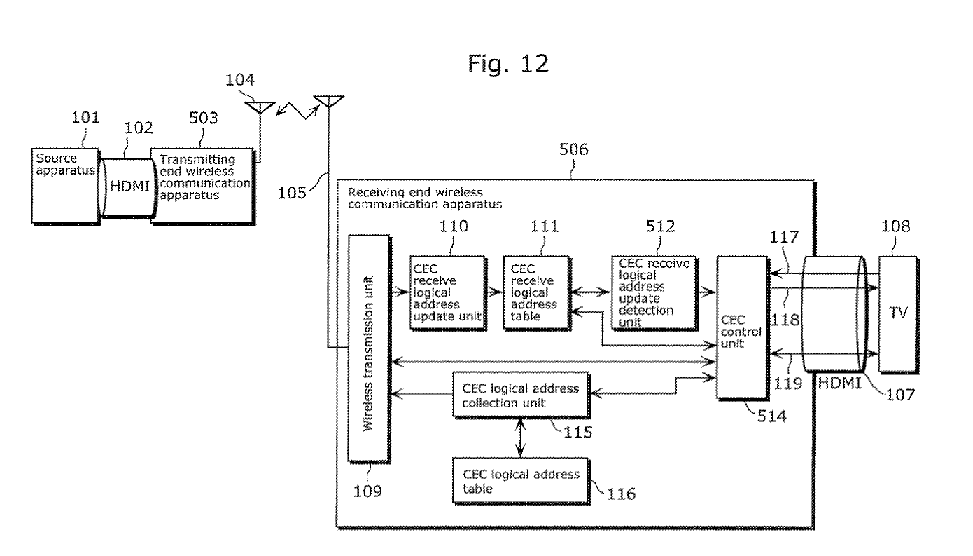

FIG. 12 is a block diagram showing a configuration of a wireless communication system that includes the wireless communication apparatus according to the embodiment 5 of the present invention. In FIG. 12, the same constituents as those of the embodiments 1 to 4 will be given the same numeral, and description thereof will not be repeated. The transmitting-end wireless communication apparatus 503 and the receiving-end wireless communication apparatus 506 are modified examples of the wireless communication apparatus 1000 shown in FIG. 1, and the correspondence between the constituents is the same as in the embodiment 1.

Referring to FIG. 12, a CEC control unit 514 generates a report physical address message, one of the CEC message specified in the HDMI Standard, upon receipt of a notice of a change in registration content from the CEC logical address collection unit 115, and outputs the report physical address message to the transmitting-end wireless communication apparatus 503 through the wireless transmission unit 109 and the antenna 105.

Hereunder, an operation according to this embodiment will be described in details.

The following description is based on the assumption that a CEC apparatus has been newly connected to the TV 408 wire-connected to the receiving-end wireless communication apparatus 506.

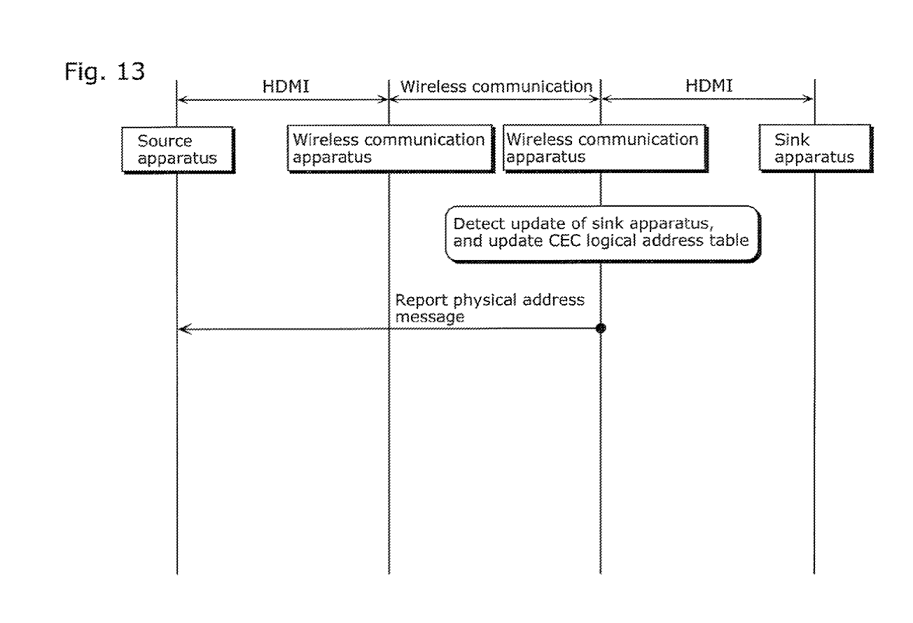

Referring to FIG. 13, the CEC logical address collection unit 115 of the receiving-end wireless communication apparatus 506 detects that the content of the CEC logical address table 116 has been updated, and notifies the update to the CEC control unit 514. The CEC control unit 514 generates a report physical address message upon receipt of the notice from the CEC logical address collection unit 115, and outputs the report physical address message to the wireless transmission unit 109. The wireless transmission unit 109 generates a wireless data packet containing the report physical address message inputted by the CEC control unit 514, and wirelessly transmits the wireless data packet through the antenna 105. Here, the report physical address message generated at this stage contains the CEC physical address and the CEC logical address of the CEC apparatus newly connected to the TV 408.

The transmitting-end wireless communication apparatus 503 generates a CEC frame containing the report physical address message upon receipt of the wireless data packet containing the report physical address message, and outputs the CEC frame to the HDMI cable 102 thereby notifying the source apparatus 101 that the system composition of the CEC apparatuses connected to the receiving-end wireless communication apparatus 506 has undergone a change.

According to the embodiment 5, in the case where the system composition of the CEC apparatuses wire-connected to the receiving-end wireless communication apparatus 506 has undergone a change, the receiving-end wireless communication apparatus 506 can notify the change in system composition to the other CEC apparatuses in the wireless communication system.

### Embodiment 6

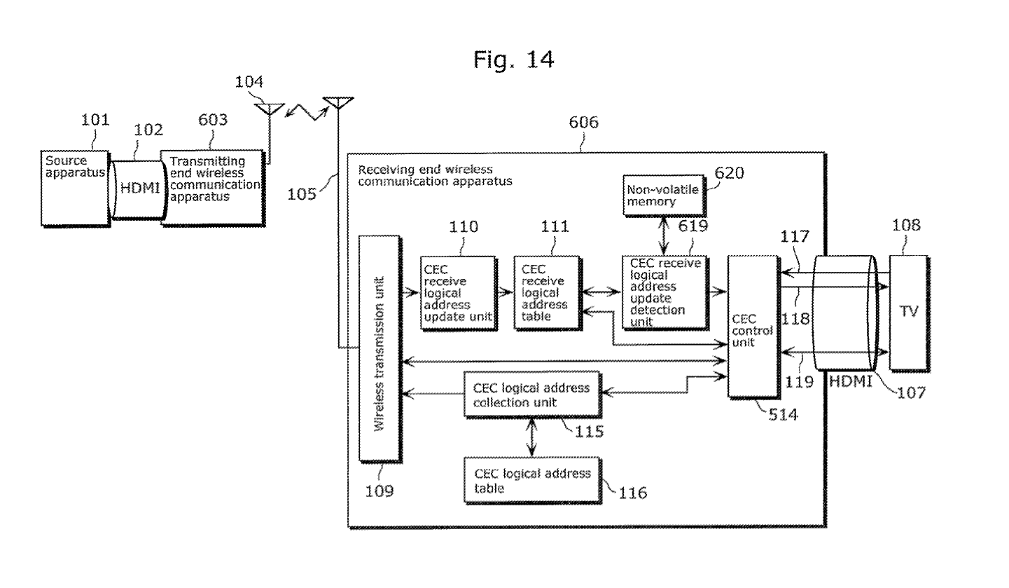

FIG. 14 is a block diagram showing a configuration of a wireless communication system that includes the wireless communication apparatus according to the embodiment 6 of the present invention. In FIG. 14, the same constituents as those of the embodiments 1 to 5 will be given the same numeral, and description thereof will not be repeated. The transmitting-end wireless communication apparatus 603 and the receiving-end wireless communication apparatus 606 are modified examples of the wireless communication apparatus 1000 shown in FIG. 1, and the correspondence between the constituents is the same as in the embodiment 1.

Referring to FIG. 14, a CEC receive logical address update detection unit 619 decides whether the CEC receive logical address table 111 has been updated. In the affirmative case, the CEC receive logical address update detection unit 619 stores (copies) the list of CEC logical addresses registered in the CEC receive logical address table 111, in a non-volatile memory 620.

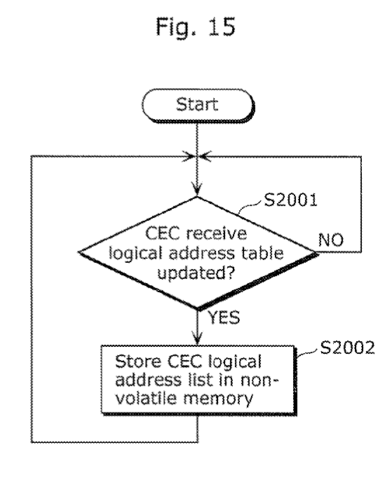

FIG. 15 is a flowchart showing an update process of the non-volatile memory 620 performed by the CEC receive logical address update detection unit 619 according to the embodiment 6.

First, the CEC receive logical address update detection unit 619 decides whether the CEC receive logical address table 111 has been updated (step S2001). In the affirmative case (YES at step S2001), the CEC receive logical address update detection unit 619 stores the list of CEC logical addresses contained in the CEC receive logical address table 111 in the non-volatile memory 620 (step S2002).

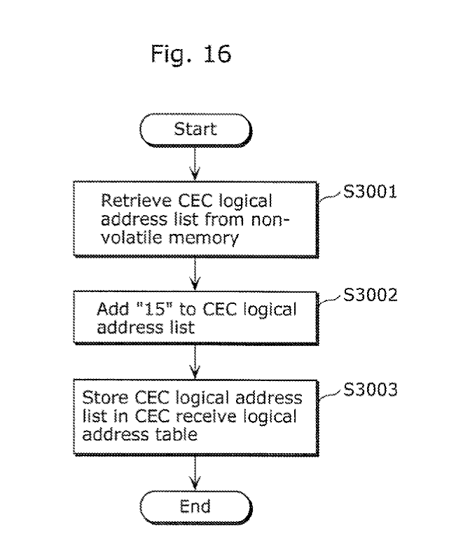

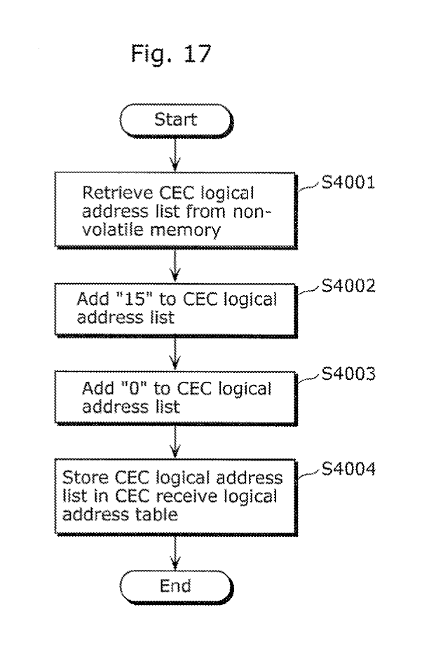

FIGS. 16 and 17 are flowcharts each showing an initialization process of the CEC receive logical address table 111 performed by the CEC receive logical address update detection unit 619 according to the embodiment 6. FIG. 16 is a flowchart showing an initialization process of the CEC receive logical address table 111 in the receiving-end wireless communication apparatus 606. FIG. 17 is a flowchart showing an initialization process of a CEC receive logical address table in the transmitting-end wireless communication apparatus 603.

Referring first to FIG. 16, the initialization process in the receiving-end wireless communication apparatus 606 will be described.

Upon activating the receiving-end wireless communication apparatus 606, the CEC receive logical address update detection unit 619 retrieves the list of CEC logical addresses from the non-volatile memory 620 (step S3001). The CEC receive logical address update detection unit 619 then adds “15”, which is a broadcast address in the CEC logical address, to the retrieved list of CEC logical addresses (step S3002). Thereafter, the CEC receive logical address update detection unit 619 stores the list of CEC logical addresses in the CEC receive logical address table 111 (step S3003).

Referring now to FIG. 17, the initialization process in the transmitting-end wireless communication apparatus 603 will be described.

Steps S4001, S4002, and S4004 of the initialization process of the transmitting-end wireless communication apparatus 603 correspond to the steps S3001, S3002, and S3003 of the initialization process of the receiving-end wireless communication apparatus 606, respectively. A difference is that FIG. 17 additionally includes a step S4003 of adding “0” representing the logical address of the root apparatus (TV 108 in this embodiment) to the list of CEC logical addresses, between the steps S4002 and S4004.

According to this embodiment, the CEC receive logical address table 111 constantly contains the CEC logical address “15”. Accordingly, a CEC message to a broadcast address can be constantly received and wirelessly relayed, immediately upon activating the receiving-end wireless communication apparatus 606. Therefore, on the assumption that the CEC apparatus newly connected to the CEC signal line 119 is to first issue a CEC message to a broadcast address, the CEC control unit 514 can always relay the CEC message for a broadcast address from the CEC apparatus newly connected to the CEC signal line 119.

In this case, collecting the source CEC logical addresses of the CEC message in the CEC logical address collection unit 115 enables acquisition of the CEC logical address of the CEC apparatus connected to the CEC signal line 119. Such an arrangement eliminates the need to periodically perform polling through the CEC signal line 119, thereby reducing the traffic through the CEC signal line 119.

Also, immediately after the initialization, the CEC receive logical address table 111 contains the list of CEC logical addresses that was contained when the receiving-end wireless communication apparatus 606 was turned off last. Accordingly, in the case where the assignment of the CEC logical addresses to the CEC apparatuses has not been updated during the period between the last turning off and the latest activation, the wireless relay transmission of a CEC message can be performed without the need to, for example, receive a list exchange message from the transmitting-end wireless communication apparatus 603.

Further, the CEC receive logical address table of the transmitting-end wireless communication apparatus 603 contains the CEC logical address “0” given to a root apparatus connected to the receiving-end wireless communication apparatus 606 in an initial state. Accordingly, a CEC message destined for the TV 108, which is the root apparatus in this embodiment, can be received and wirelessly relayed immediately upon activation.

Here, the embodiment 6 of the present invention may be combined with any of the embodiments 1 to 5 of the present invention.

Also, the wireless communication apparatuses according to different ones of the embodiments 1 to 6 of the present invention may be combined.

Although a single wireless communication apparatus is provided on the transmitting-end and the receiving-end according to the embodiments 1 to 6 of the present invention, a plurality of wireless communication apparatuses may be provided on either or both ends.

### ADDITIONAL VARIATIONS

Although the present invention has been described with reference to the foregoing embodiment, naturally the present invention is not limited to the embodiment. The following examples are also within the scope of the present invention.

The units referred to above are actually a computer system including a microprocessor, a ROM, a RAM, a hard disk unit, a display unit, a keyboard, a mouse, and so forth. The RAM and the hard disk unit store therein a computer program. By operation of the microprocessor according to the computer program, the units perform the respective functions. The computer program is composed of a plurality of combinations of command codes each giving an instruction to the computer for executing a predetermined function.

A part of the constituents of the foregoing units or the whole thereof may be contained in a single system large-scale integration (LSI). The system LSI is an ultra-multifunction LSI containing a plurality of constituents integrated on a single chip, which can be specifically exemplified by a computer system including a microprocessor, a ROM, a RAM, and so on. The RAM stores therein a computer program. By operation of the microprocessor according to the computer program, the system LSI performs the functions.

A part of the constituents of the foregoing units or the whole thereof may be contained in an IC card or a single module that can be removably attached to the constituents. The IC card or the module is a computer system including a microprocessor, a ROM, a RAM, and so forth. The IC card or the module may include the ultra-multifunction LSI. By operation of the microprocessor according to the computer program, the IC card or the module performs the functions. The IC card or the module may be tamper-resistant.

The present invention may be realized in a form of the methods stated in the foregoing descriptions. Alternatively, the present invention may be realized as a computer program that causes a computer to perform those methods, or as a digital signal composed of the computer program.

Also, the present invention may be realized as a computer-readable recording medium such as a flexible disk, a hard disk, a CD-ROM, a MO, a DVD, a DVD-ROM, a DVD-RAM, a BD, or a semiconductor memory, containing a computer program or a digital signal. Alternatively, the present invention may be realized in a form of the digital signal recorded in the foregoing recording media.

Further, the present invention may include transmitting the computer program or the digital signal through an electrical communication line, a wireless or wired communication line, a network typically exemplified by the Internet, a data broadcast, and so forth.

Further, the present invention may be realized as a computer system including a microprocessor and a memory, and the memory may store therein the computer program, and the microprocessor may be configured to operate in accordance with the computer program.

Still further, the present invention may be realized by means of another independent computer system, by transferring the program or the digital signal recorded in a recording medium, or transmitting the program or the digital signal through a network.

The foregoing embodiment and one or more of the variations may be combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The wireless communication apparatus according to the present invention significantly improves a throughput in a CEC wireless relay transmission. Also, in the case where a connection status of CEC apparatuses or assignment of logical addresses is changed, such a change can be instantly notified to the other apparatuses associated with the HDMI. Accordingly, the present invention is advantageously applicable to a wireless communication system designed for wireless relay transmission of an HDMI-CEC message.

### REFERENCE SIGNS LIST

1A Source apparatus

2A Sink apparatus

10A, 20A, 50, 60 Controller

11, 21 ROM

13 DVD player

14, 24 CEC controller

22 Speaker

23 Display

30 Audio/visual signal processing circuit

51, 55, 61, 65 Wired transmission/reception circuit

52, 62 RAM

54, 64 Wireless transmission/reception circuit

56, 66, 104, 105 Antenna

57, 67 Adapter

101 Source apparatus

102, 107 HDMI cable

103, 203, 303, 403, 503, 603 Transmitting-end wireless communication apparatus

106, 206, 306, 406, 506, 606 Receiving-end wireless communication apparatus

108, 408 TV

109 Wireless transmission unit

110 CEC receive logical address update unit

111 CEC receive logical address table

112, 212, 512, 619 CEC receive logical address update detection unit

114, 214, 314, 414, 514 CEC control unit

115 CEC logical address collection unit

116 CEC logical address table

117 HPD signal line

118 “+5 V Power” signal line

119 CEC signal line

620 Non-volatile memory

1000 Wireless communication apparatus

1100 Wired interface

1200 Wireless interface

1300 Address management table

1400 Table update unit

1500 Control unit

1. A wireless communication apparatus being one of a pair of wireless communication apparatuses wireless-connected to each other, each wireless communication apparatus being wire-connected to one or more apparatuses, said wireless communication apparatus comprising:
a wired interface wire-connected to the one or more apparatuses in accordance with the High-Definition Multimedia Interface (HDMI) Standard;
a wireless interface wireless-connected to the other of the pair of wireless communication apparatuses;
an address management table that stores a CEC logical address for identifying the respective apparatus wire-connected to the pair of wireless communication apparatuses;
a table update unit configured to update said address management table upon receipt of a message indicating that the apparatus connected on the side of one of said wired interface and said wireless interface has been changed; and
a control unit configured to notify the apparatus connected on the side of the other of said wired interface and said wireless interface that said table update unit has updated said address management table.

2. The wireless communication apparatus according to claim 1,
wherein said table update unit is configured to update, upon receipt of a list exchange message containing a list of CEC logical addresses of the apparatuses wire-connected to the other wireless communication apparatus from the other wireless communication apparatus through said wireless interface, said address management table with the CEC logical address contained in the list exchange message, and
said control unit is configured to output a LOW-level pulse for a predetermined period of time to a “Hot Plug Detect” signal line or a “+5 V Power” signal line included in said wired interface, to thereby notify the apparatus connected on the side of said wired interface that said address management table has been updated.

3. The wireless communication apparatus according to claim 2,
wherein said control unit is further configured to continue outputting the LOW-level pulse to the “Hot Plug Detect” signal line or the “+5 V Power” signal line included in said wired interface, until a first receipt of the list exchange message from the other wireless communication apparatus after said wireless communication apparatus is activated.

4. The wireless communication apparatus according to claim 1,
wherein said table update unit is configured to add, upon receipt of a given CEC message through said wireless interface, a CEC logical address indicating the source of the CEC message to said address management table in the case where the CEC logical address is not contained in said address management table; and
said control unit is configured to transmit a report physical address message specified in the HDMI Standard to the apparatus connected on the side of said wired interface, to thereby notify the CEC logical address added to said address management table.

5. The wireless communication apparatus according to claim 4,
wherein said control unit is configured to transmit a give physical address message specified in the HDMI Standard to the apparatus identified by the added CEC logical address, and to relay the report physical address message generated by the identified apparatus to the apparatus connected on the side of said wired interface.

6. The wireless communication apparatus according to claim 1,
wherein said table update unit is configured to add, upon receipt of a given CEC message through said wired interface, a CEC logical address indicating the source of the CEC message to said address management table in the case where the CEC logical address is not contained in said address management table; and
said control unit is configured to transmit a report physical address message specified in the HDMI Standard to the apparatus connected on the side of said wireless interface, to thereby notify the CEC logical address added to said address management table.

7. The wireless communication apparatus according to claim 6,
wherein said control unit is configured to transmit a give physical address message specified in the HDMI Standard to the apparatus identified by the added CEC logical address, and to relay the report physical address message generated by the identified apparatus to the apparatus connected on the side of said wireless interface.

8. The wireless communication apparatus according to claim 1, further comprising
a non-volatile memory;
wherein said table update unit is configured to store, each time said address management table is updated, a copy of one or more of the CEC logical addresses contained in said updated address management table in said non-volatile memory.

9. The wireless communication apparatus according to claim 8,
wherein said table update unit is configured to add, when said wireless communication apparatus is activated, at least one of a CEC logical address indicating a root apparatus and a broadcast address to the one or more CEC logical addresses stored in said non-volatile memory, and to store a copy of the added address in said address management table.

10. The wireless communication apparatus according to claim 1,
wherein said control unit is configured to transmit, upon receipt of a given CEC message through said wired interface, the CEC message to the destination apparatus through said wireless interface, and to transmit an acknowledgement signal indicating the receipt of the CEC message to the apparatus that is the source of the CEC message through said wired interface, in the case where the CEC logical address indicating a destination of the CEC message is contained in said address management table.

11. A method of wireless communication to be executed by a wireless communication apparatus being one of a pair of wireless communication apparatuses wireless-connected to each other, each wireless communication apparatus being wire-connected to one or more apparatuses, for wireless communication with the other of the pair of wireless communication apparatuses,
the one of the pair of wireless communication apparatuses including:
a wired interface wire-connected to the one or more apparatuses in accordance with the High-Definition Multimedia Interface (HDMI) Standard, a wireless interface wireless-connected to the other of the pair of wireless communication apparatuses, and
an address management table containing a CEC logical address for identifying the respective apparatus wire-connected to the pair of wireless communication apparatuses,
said method comprising:
updating the address management table upon receipt of a message indicating that the apparatus connected on the side of one of the wired interface and the wireless interface has been changed; and
notifying the apparatus connected on the side of the other of the wired interface and the wireless interface that the address management table has been updated in said updating the address management table.

12. A non-transitory computer-readable recording medium for use in a computer, said recording medium having a computer program recorded thereon for causing a wireless communication apparatus being one of a pair of wireless communication apparatuses wireless-connected to each other, each wireless communication apparatus being wire-connected to one or more apparatuses, to perform wireless communication with the other of the pair of wireless communication apparatuses,
the one of the pair of wireless communication apparatuses including:
a wired interface wire-connected to the one or more apparatuses in accordance with the High-Definition Multimedia Interface (HDMI) Standard, a wireless interface wireless-connected to the other of the pair of wireless communication apparatuses; and
an address management table containing a CEC logical address for identifying the respective apparatus wire-connected to the pair of wireless communication apparatuses;
the program causing the one of the pair of wireless communication apparatuses to:
update the address management table upon receipt of a message indicating that the apparatus connected on the side of one of the wired interface and the wireless interface has been changed; and
notify the apparatus connected on the side of the other of the wired interface and the wireless interface that the address management table has been updated in the updating of the address management table.

13. An integrated circuit for use in a wireless communication apparatus being one of a pair of wireless communication apparatuses wireless-connected to each other, each wireless communication apparatus being wire-connected to one or more apparatuses,
the one of the pair of wireless communication apparatuses including:
a wired interface wire-connected to the one or more apparatuses in accordance with the HDMI Standard; and
a wireless interface wireless-connected to the other of the pair of wireless communication apparatuses,
said integrated circuit comprising:
an address management table configured to store a CEC logical address for identifying the respective apparatus wire-connected to the pair of wireless communication apparatuses;
a table update unit configured to update said address management table upon receipt of a message indicating that the apparatus connected on the side of one of the wired interface and the wireless interface has been changed; and
a control unit configured to notify the apparatus connected on the side of the other of the wired interface and the wireless interface that said address management table has been updated by said table update unit.
